(19) United States
(12) Patent Application Publication
(10) Pub. No.: US 2024/0400026 A1
(43) Pub. Date: Dec. 5, 2024

(54) ACTUATOR SUB-ASSEMBLY AND BRAKE BLOCK

(71) Applicants: ZF Active Safety US Inc., Livonia, MI (US); ZF Active Safety GmbH, Koblenz (DE)

(72) Inventors: Galus Chelaidite, South Lyon, MI (US); Daniel Schwarz, Koblenz (DE); Lucas Madzgalla, Lahnstein (DE)

(21) Appl. No.: 18/327,150

(22) Filed: Jun. 1, 2023

(51) Int. Cl. B60T 13/74; B60T 1/06; F16D 55/226; F16D 65/095; F16D 65/18

(52) U.S. Cl. CPC B60T 13/746; B60T 1/065; F16D 55/226; F16D 65/095; F16D 65/18; F16D 2121/24; F16D 2125/40

(57) ABSTRACT

An actuator sub-assembly (12) for a vehicle brake (10) is set out, having a brake caliper (14), in which an intermediate space (16) for a brake rotor (18) is formed, wherein in the intermediate space (16) there is arranged a brake block (20) which can be applied to the brake rotor (18), and having a spindle drive (16) which has a spindle nut (30) and an electromotively driven spindle (28) for axially moving the spindle nut (30), wherein the spindle nut (30) can be displaced by means of axial displacement between an extended position and a retracted position and has an end face (32) which faces the brake block (20). Between the spindle nut (30) and the brake block (20) there is provided between adjacent portions a convex-curved uncoupling face (48) which transmits an axial advance force of the spindle nut (30) in the direction towards the brake block (20) and along which the adjacent portions can be moved relative to each other in at least one direction. A brake block is further set out.

### TECHNICAL FIELD

The invention relates to an actuator sub-assembly for a vehicle brake and a brake block for an actuator sub-assembly.

### BACKGROUND

Actuator sub-assemblies are used in vehicle brakes to apply a brake block to a brake rotor. To this end, the actuator sub-assembly generally has a spindle drive which has a spindle nut and an electromotively driven spindle for axially moving the spindle nut, wherein an axial advance force for applying the brake block to the brake rotor is transmitted from the spindle nut to the brake block.

When the vehicle brake is activated, high transverse forces act on the brake block and the spindle nut, whereby a bending torque is brought about in the actuator sub-assembly. Such transverse forces are undesirable since they lead to a performance and efficiency loss and promote wear of the actuator sub-assembly. The transverse forces which occur change over the service-life of the actuator sub-assembly as a result of liner wear, which can lead to occurrences of imprecision when the vehicle brake is controlled or to changes in the brake behaviour.

In known actuator sub-assemblies, a spherical bearing disc is arranged on an abutment face, facing away from the brake block, of the spindle. However, this eliminates transverse forces in the actuator sub-assembly only in an inadequate manner as a result of the relatively large distance with respect to the brake block.

### SUMMARY

An object of the present invention is therefore to provide an improved solution for preventing transverse forces in an actuator sub-assembly of a vehicle brake.

This object is achieved according to the invention with an actuator sub-assembly for a vehicle brake, having a brake caliper in which an intermediate space for a brake rotor is formed, wherein in the intermediate space there is arranged a brake block which can be applied to the brake rotor and having a spindle drive which has a spindle nut and an electromotively driven spindle for axially moving the spindle nut, wherein the spindle nut can be displaced by means of axial displacement between an extended position and a retracted position and has an end face which faces the brake block. Between the spindle nut and the brake block there is provided between adjacent portions a convex-curved uncoupling face which transmits an axial advance force of the spindle nut in the direction towards the brake block and along which the adjacent portions can be moved relative to each other in at least one direction. In particular, the adjacent portions can be displaced along the uncoupling face relative to each other in a linearly displaceable and/or pivotable manner.

As a result of the uncoupling face, transverse forces and bending torques are largely prevented in the actuator sub-assembly so that less wear occurs and consequently the service-life of the actuator sub-assembly is increased. By transverse forces being prevented, the pressure on axial bearings which are present in the actuator sub-assembly is also relieved. Loss forces as a result of friction are also reduced, whereby an efficiency of the actuator sub-assembly is optimised.

In a vehicle brake with an actuator sub-assembly according to the invention, a pressure distribution on the brake block is also particularly uniform, whereby a wear which is uniform when considered over the surface-area take place. In other words, diagonal wear is prevented.

The advantages according to the invention are inter alia achieved in that the uncoupling face is arranged between the spindle nut and the brake block, that is to say, close to a force introduction location, and transverse forces are not transmitted further into the actuator sub-assembly.

The movement along the uncoupling face, in particular a pivot movement or a lateral displacement, takes place during the application of the brake block against the brake rotor before the maximum clamping force is reached. This is because the friction along the uncoupling face increases with increasing clamping force so that from a specific level of the clamping force, in particular at maximum clamping force, a compensation at the uncoupling face is hardly still possible.

According to one embodiment, the portion which adjoins the portion with the convex uncoupling face has a complementarily shaped concave counter-face against which the uncoupling face abuts. In this manner, a particularly precisely defined contact face is produced between the two portions between which the uncoupling face is present. Particularly between the two portions, a pivot movement but not a linear displacement is possible. A lateral offset between the two portions is consequently prevented, whereby an orientation of the portions relative to each other is maintained up to a specific degree.

In an alternative embodiment, the portion which adjoins the portion with the convex uncoupling face may have a planar counter-face against which the uncoupling face abuts. As a result of the flat counter-face, both a pivot movement and a linear, lateral movement is possible between the two portions, whereby transverse forces are prevented in a particularly effective manner.

The spindle drive may have an actuation carriage which can be displaced axially through the spindle nut and which is laterally supported in the brake caliper and which is located on the spindle nut and presses against the brake block, particularly when the spindle nut is in an extended position. By the actuation carriage and the spindle nut being produced separately, the complexity of the individual portions can be reduced, whereby the production is simplified.

The uncoupling face is, for example, provided between the actuation carriage and spindle nut. The transverse forces which occur are consequently not transmitted into the spindle drive. Furthermore, as a result of the arrangement of the uncoupling face between the actuation carriage and the spindle nut, a movement of the actuation carriage relative to the spindle nut is limited, in particular by the inner wall of the actuation carriage striking the spindle nut. A displacement of the components relative to each other which from a specific degree could have an effect on the function of the actuator sub-assembly is consequently limited.

The spindle nut has, for example, a convex end face which forms the uncoupling face and the opposing face on the actuation carriage is formed in a planar or concave manner, wherein the actuation carriage can be moved relative to the spindle nut and during the movement the face on the actuation carriage slides laterally along the uncoupling face and/or is pivoted relative to the uncoupling face. As already explained above, a planar face on the actuation carriage enables a pivoting and a lateral displacement whilst a concave-curved face on the actuation carriage enables only a pivoting of the actuation carriage relative to the spindle nut.

The actuation carriage constitutes in particular a brake piston.

In an alternative embodiment, the actuation carriage may form the spindle nut, whereby the number of components in the actuator sub-assembly is reduced. In other words, the spindle nut itself may constitute a brake piston.

The brake block may have a rear plate for a friction liner which has a rear side which has the uncoupling face or the counter-face relative to the uncoupling face. By the uncoupling face being provided directly on or directly adjacent to the brake block, the uncoupling face is arranged directly at the force introduction location at which the undesirable transverse forces occur. In other words, as a result of such an arrangement of the uncoupling face, a production of transverse forces is prevented from the outset.

The uncoupling face or the counter-face to the uncoupling face directly on the rear plate of the brake block may alternatively or additionally to the uncoupling face be provided between the spindle nut and actuation carriage.

In another embodiment, an interposed disc which is convex at least at one end face and which forms the uncoupling face may be provided in the region between the spindle nut and brake block. As a result of such a convex interposed disc, the uncoupling face is formed on a separate component, which performs no further function other than the uncoupling in the actuator sub-assembly.

The spindle drive is, for example, a ball screw drive. Such a spindle drive is advantageous in that, as a result of the balls which are caused to carry out a rolling movement during a rotation of the spindle, there is only a minimal friction between the spindle and the spindle nut. However, it is also conceivable for the spindle drive to comprise a friction spindle or a trapezoidal spindle.

The spindle nut is preferably guided in a rotationally secure manner on the brake caliper. Consequently, a rotation of the spindle is converted completely into an axial movement of the spindle nut.

For example, the actuator sub-assembly comprises an electric motor, which is coupled to the spindle nut in terms of driving by means of a gear unit and the spindle drive in order to displace the spindle nut between the retracted position and the extended position. The actuator sub-assembly is consequently an electromechanical actuator sub-assembly. By means of an electric motor a sufficiently large force can be produced in order to apply a friction liner by means of the actuation carriage to a brake rotor.

Preferably, the spindle of the spindle drive is supported at a side facing away from the spindle nut by means of an axial bearing on a wall which extends transversely with respect to the movement direction of the spindle nut. Consequently, axial forces which act when the actuator sub-assembly is actuated and which occur particularly when the brake block is applied to the brake rotor are transmitted to the wall.

The object is further achieved according to the invention by a brake block for a vehicle brake having an actuator sub-assembly according to the invention, characterized in that the brake block has a friction liner and a rear plate which is secured to the friction liner, wherein the rear plate has a contact region for contacting by a spindle nut or an actuation carriage, and the rear plate is curved in a convex or concave manner in the contact region. In other words, on the rear plate in the contact region for contacting by the spindle nut or the actuation carriage, the uncoupling face or a counter-face which is formed in a manner complementary to the uncoupling face is present. As already described in connection with the actuator sub-assembly according to the invention, by means of such a brake block, transverse forces and bending torques in an actuator sub-assembly of a vehicle brake can be prevented.

### BRIEF DESCRIPTION OF THE DRAWINGS

Other advantages and features of the invention will be appreciated from the following description and from the appended drawings, to which reference is made. In the drawings:

FIG. 1 shows a vehicle brake having an actuator sub-assembly according to the invention,

FIG. 2 shows a portion of a vehicle brake having an actuator sub-assembly according to the invention in the region of a contact region for contacting a brake block according to the invention by a spindle nut,

FIG. 3 shows a portion of an alternative vehicle brake having an actuator sub-assembly according to the invention and a brake block according to the invention, and

FIG. 4 shows a portion of another alternative vehicle brake having an actuator sub-assembly according to the invention.

### DESCRIPTION

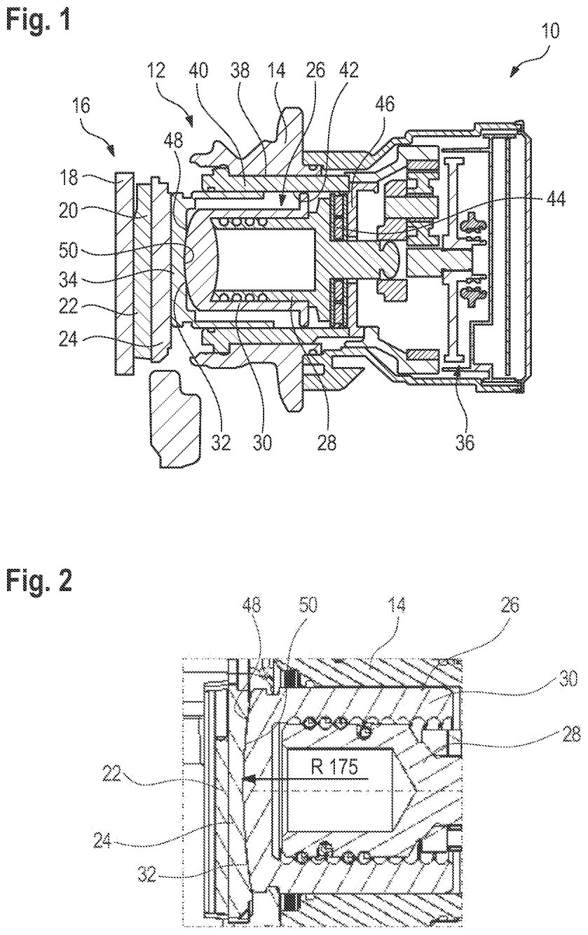

FIG. 1 shows a vehicle brake 10 having an actuator sub-assembly 12. The vehicle brake 10 is an electromechanically actuatable brake.

The actuator sub-assembly 12 comprises a brake caliper 14 in which an intermediate space 16 for a brake rotor 18 is formed.

In the intermediate space there is arranged a brake block 20 which can be applied to the brake rotor 18.

The brake block 20 has a friction liner 22 and a rear plate 24 which is connected to the friction liner.

Furthermore, the actuator sub-assembly 12 comprises a spindle drive 26 which in the embodiment is a ball screw drive having a rotatably supported, electromotively driven spindle 28 on which a spindle nut 30 is supported. The spindle 28 serves to axially move the spindle nut 30.

Specifically, the spindle nut 30 can be displaced by means of axial displacement between an extended position and a retracted position.

The spindle nut 30 has an end face 32 facing the brake block 20.

In the embodiment according to FIG. 1, the spindle drive 26 has an actuation carriage 34 which can be displaced axially through the spindle nut 30 and which is laterally supported in the brake caliper 14 and which is located on the spindle nut 30 and presses against the brake block 20.

In specific terms, the actuation carriage 34 constitutes a brake piston.

The actuator sub-assembly 12 further comprises an electric motor which cannot be seen in FIG. 1.

The electric motor is coupled to the spindle nut 30 in terms of driving by means of a gear unit 36 and the spindle drive 26 in order to displace the spindle nut 30 between the retracted position and the extended position.

An axial displacement of the spindle nut 30 is in particular brought about by means of rotation of the spindle 28.

In the brake caliper 14, there is formed a recess 38 in which a sleeve 40 is inserted. A running face 42 for the spindle nut 30 is formed on the sleeve 40.

The spindle nut 30 is guided in a linearly displaceable manner in the sleeve 40.

In an alternative embodiment, the sleeve 40 may be dispensed with and the running face 42 can be formed directly on the recess 38 in the brake caliper 14.

The spindle nut 30 is in particular guided in a rotationally secure manner on the running face 42.

The spindle 28 of the spindle drive 26 is supported at a side facing away from the spindle nut 30 by means of an axial bearing 44 on a wall 46 which extends transversely relative to the movement direction of the spindle nut 30.

Between the spindle nut 30 and the brake block 20 a convex-curved uncoupling face 48 is provided between adjacent portions.

In the embodiment according to FIG. 1, the uncoupling face 48 is provided between the spindle nut 30 and the actuation carriage 34.

The uncoupling face 48 transmits an axial advance force of the spindle nut 30 in the direction towards the brake block 30.

Along the uncoupling face 48, the adjacent portions can be moved relative to each other in at least one direction. More specifically, the adjacent portions can be pivoted relative to each other and/or linearly displaced laterally relative to each other. In this manner, an introduction of transverse forces into the actuator sub-assembly 12 is prevented or significantly reduced. In other words, as a result of the uncoupling face 48 a mechanical uncoupling takes place to some degree between the adjacent portions.

The portion which adjoins the portion with the convex uncoupling face 48, in the Figure the actuation carriage 34, may have a planar counter-face 50 or a concave counter-face 50 which is formed in a manner complementary to the uncoupling face 48 and against which the uncoupling face 48 abuts.

In the embodiment according to FIG. 1, the counter-face 50 is planar.

In specific terms, the spindle nut 30 has a convex end face 32 which forms the uncoupling face 48 and the opposing face on the actuation carriage 34 is formed in a planar manner and forms the counter-face 50.

The actuation carriage 34 can be moved relative to the spindle nut 30 and, during the movement, the face slides laterally on the actuation carriage 34 along the uncoupling face 48 and/or is pivoted relative to the uncoupling face 48.

In an alternative embodiment, the counter-face on the actuation carriage 34 may be concave.

In any case, the axial advance force of the brake is transmitted via the end face 32.

In FIG. 2, another embodiment of a vehicle brake 10 having an actuator sub-assembly 12 is illustrated.

In contrast to the actuator sub-assembly 12 illustrated in FIG. 1, in the actuator sub-assembly 12 illustrated in FIG. 2 the uncoupling face 48 is provided between the spindle nut 30, which in the embodiment according to FIG. 2 at the same time forms a brake piston, and the brake block 20.

More specifically, the uncoupling face 48 is provided on the spindle nut 30 and a rear side of the rear plate 24 of the brake block 20 has the counter-face 50 with respect to the uncoupling face 48.

In other words, the rear plate 24 has a contact region for contacting by the spindle nut 30 and the rear plate is curved in a complementary and concave manner in the contact region.

In an alternative embodiment, which is not illustrated for the sake of simplicity, the actuator sub-assembly 12 may have an actuation carriage 34 which is separate from the spindle nut 30 and on which the convex-curved uncoupling face 48 is arranged.

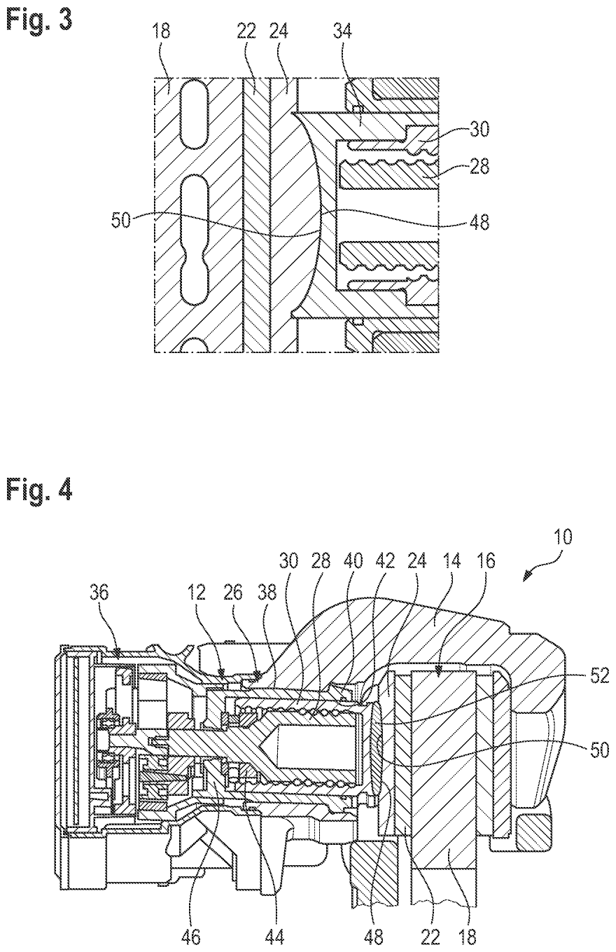

In the embodiment illustrated in FIG. 3, the uncoupling face 48 is also arranged between the actuation carriage 34 and the brake block 20. In the embodiment according to FIG. 3, however, the uncoupling face 48 is arranged on the rear side of the rear plate 24 and the counter-face 50 is arranged on the actuation carriage 34. That is to say, the actuation carriage 34 is curved in a concave manner at the end face directed towards the brake block 20 and the rear plate 24 is curved in a convex manner in the contact region for contacting by the actuation carriage 34.

FIG. 4 shows a vehicle brake 10 having an actuator sub-assembly 12 according to another embodiment, in which the uncoupling face 48 is formed on an interposed disc 52 which is provided in the region between the spindle nut 30 and brake block 20.

The spindle nut 30 forms the brake piston in the embodiment according to FIG. 4.

The interposed disc 52 is secured either to the spindle nut 30 or to the brake block 20, more specifically to the rear plate 24 of the brake block.

The counter-face 50 with respect to the uncoupling face 48 is accordingly provided on the face which is opposite the interposed disc 52.

Another difference of the embodiment illustrated in FIG. 4 is the shape of the axial bearing 44.

In the embodiment according to FIG. 4, the axial bearing 44 has a spherical contact face with the spindle 28. The transverse forces which in spite of the uncoupling face 48 can be introduced into the spindle drive 26 can thereby be received in the axial bearing 44 and transmitted to the brake caliper 14.

The axial bearing 44 illustrated in FIG. 4 can similarly be present in the actuator sub-assemblies 12 illustrated in FIGS. 1 to 3.

1. Actuator sub-assembly (12) for a vehicle brake (10) having
a brake caliper (14), in which an intermediate space (16) for a brake rotor (18) is formed, wherein in the intermediate space (16) there is arranged a brake block (20) which can be applied to the brake rotor (18), and having
a spindle drive (16) which has a spindle nut (30) and an electromotively driven spindle (28) for axially moving the spindle nut (30), wherein the spindle nut (30) can be displaced by means of axial displacement between an extended position and a retracted position and has an end face (32) which faces the brake block (20),
wherein between the spindle nut (30) and the brake block (20) there is provided between adjacent portions a convex-curved uncoupling face (48) which transmits an axial advance force of the spindle nut (30) in the direction towards the brake block (20) and along which the adjacent portions can be moved relative to each other in at least one direction.

2. The actuator sub-assembly (12) according to claim 1, wherein the portion which adjoins the portion with the convex uncoupling face (48) has a particularly complementarily shaped concave counter-face (50) against which the uncoupling face (48) abuts.

3. The actuator sub-assembly (12) according to claim 1, wherein the portion which adjoins the portion with the convex uncoupling face (48) has a planar counter-face (50) against which the uncoupling face (48) abuts.

4. The actuator sub-assembly (12) claim 1, wherein the spindle drive (26) has an actuation carriage (34) which can be displaced axially through the spindle nut (30) and which is laterally supported in the brake caliper (14) and which is located on the spindle nut (30) and presses against the brake block (20).

5. The actuator sub-assembly (12) according to claim 4, wherein the uncoupling face (48) is provided between the actuation carriage (34) and spindle nut (30).

6. The actuator sub-assembly (12) according to claim 5, wherein the spindle nut (30) has a convex end face (32) which forms the uncoupling face (48) and the opposing face on the actuation carriage (34) is formed in a planar or concave manner, wherein the actuation carriage (34) can be moved relative to the spindle nut (30) and during the movement the face on the actuation carriage (34) slides laterally along the uncoupling face (48) and/or is pivoted relative to the uncoupling face (48).

7. Actuator sub-assembly (12) according to claim 1, wherein the brake block (20) has a rear plate (24) for a friction liner (22) which has a rear side which has the uncoupling face (48) or the counter-face (50) relative to the uncoupling face (48).

8. Actuator sub-assembly (12) according to claim 1, wherein an interposed disc (52) which is convex at least at one end face and which forms the uncoupling face (48) is provided in the region between the spindle nut (30) and brake block (20).

9. Actuator sub-assembly (12) according to claim 1, wherein the spindle drive (26) is a ball screw drive.

10. Actuator sub-assembly (12) according to claim 1, wherein the spindle nut (30) is guided in a rotationally secure manner on the brake caliper (14).

11. Actuator sub-assembly (12) according to claim 1, wherein the actuator sub-assembly (12) comprises an electric motor which is coupled to the spindle nut (30) in terms of driving by means of a gear unit (36) and the spindle drive (26) in order to displace the spindle nut (30) between the retracted position and the extended position.

12. Actuator sub-assembly (12) according to claim 1, wherein the spindle (28) of the spindle drive (26) is supported at a side facing away from the spindle nut (30) by means of an axial bearing (44) on a wall (46) which extends transversely with respect to the movement direction of the spindle nut (30).

13. Brake block (20) for a vehicle brake (10) having an actuator sub-assembly (12) according to claim 1, wherein the brake block (20) has a friction liner (22) and a rear plate (24) which is secured to the friction liner (22), wherein the rear plate (24) has a contact region for contacting by a spindle nut (30) or an actuation carriage (34), wherein the rear plate (24) is curved in a convex or concave manner in the contact region.
